(19) United States
(12) Patent Application Publication
(10) Pub. No.: US 2024/0283597 A1
(43) Pub. Date: Aug. 22, 2024

(54) FEEDBACK INDICATING QUALITY OF REFERENCE SIGNAL SOUNDING OCCASIONS

(71) Applicant: QUALCOMM Incorporated, San Diego, CA (US)

(72) Inventors: Ahmed ELSHAFIE, San Diego, CA (US); Yu ZHANG, San Diego, CA (US); Hwan Joon KWON, San Diego, CA (US); Alexandros MANOLAKOS, Escondido, CA (US)

(21) Appl. No.: 18/571,540

(22) PCT Filed: Aug. 4, 2021
(86) PCT No.: PCT/CN2021/110446

§ 371 Date: Dec. 18, 2023

(51) Int. Cl. H04L 5/00; H04B 7/04

(52) U.S. Cl. CPC H04L 5/005; H04B 7/04013

(57) ABSTRACT

Aspects of the present disclosure provide apparatus, methods, processing systems, and computer readable mediums for wireless communications by a UE. A method may generally include receiving a plurality of reference signals in a plurality of reference signal sounding occasions. The method further includes transmitting, to a network entity, first one or more indications of first one or more reference signal sounding occasions associated with a first level of channel quality and second one or more indications of second one or more reference signal sounding occasions associated with a second level of channel quality.

### INTRODUCTION

Aspects of the present disclosure relate to wireless communications, and more particularly, to precoding techniques, such as for a reconfigurable intelligent surface (RIS).

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved communications between devices in a wireless network.

Certain aspects provide a user equipment (UE) including a memory and a processor coupled to the memory. The memory and the processor are generally configured to receive a plurality of reference signals in a plurality of reference signal sounding occasions. The memory and the processor are further configured to transmit, to a network entity, first one or more indications of first one or more reference signal sounding occasions associated with a first level of channel quality and second one or more indications of second one or more reference signal sounding occasions associated with a second level of channel quality.

Certain aspects provide a network entity including a memory and a processor coupled to the memory. The memory and the processor are generally configured to transmit a plurality of reference signals in a plurality of reference signal sounding occasions. The memory and the processor are further configured to receive, from, a UE, first one or more indications of first one or more reference signal sounding occasions associated with a first level of channel quality and second one or more indications of second one or more reference signal sounding occasions associated with a second level of channel quality. The memory and the processor are further configured to transmit to a reconfigurable intelligent surface (RIS) controller a third indication of a beamforming configuration for use by the RIS controller, the third indication based on the first one or more indications and the second one or more indications.

Certain aspects provide a method for wireless communications by a UE. The method generally includes receiving a plurality of reference signals in a plurality of reference signal sounding occasions. The method further includes transmitting, to a network entity, first one or more indications of first one or more reference signal sounding occasions associated with a first level of channel quality and second one or more indications of second one or more reference signal sounding occasions associated with a second level of channel quality.

Certain aspects provide a method for wireless communications by a network entity. The method generally includes transmitting a plurality of reference signals in a plurality of reference signal sounding occasions. The method further includes receiving, from, a UE, first one or more indications of first one or more reference signal sounding occasions associated with a first level of channel quality and second one or more indications of second one or more reference signal sounding occasions associated with a second level of channel quality. The method further includes transmitting to a RIS controller a third indication of a beamforming configuration for use by the RIS controller, the third indication based on the first one or more indications and the second one or more indications.

Certain aspects provide a non-transitory computer readable medium storing instructions that when executed by a UE cause the UE to receive a plurality of reference signals in a plurality of reference signal sounding occasions. The non-transitory computer readable medium may further cause the UE to transmit, to a network entity, first one or more indications of first one or more reference signal sounding occasions associated with a first level of channel quality and second one or more indications of second one or more reference signal sounding occasions associated with a second level of channel quality.

Certain aspects provide a non-transitory computer readable medium storing instructions that when executed by a network entity cause the network entity to transmit a plurality of reference signals in a plurality of reference signal sounding occasions. The non-transitory computer readable medium may further cause the network entity to receive, from, a UE, first one or more indications of first one or more reference signal sounding occasions associated with a first level of channel quality and second one or more indications of second one or more reference signal sounding occasions associated with a second level of channel quality. The non-transitory computer readable medium may further cause the network entity to transmit to a reconfigurable intelligent surface (RIS) controller a third indication of a beamforming configuration for use by the RIS controller, the third indication based on the first one or more indications and the second one or more indications.

Certain aspects provide a UE for wireless communications. The UE generally includes means for receiving a plurality of reference signals in a plurality of reference signal sounding occasions. The UE further includes means for transmitting, to a network entity, first one or more indications of first one or more reference signal sounding occasions associated with a first level of channel quality and second one or more indications of second one or more reference signal sounding occasions associated with a second level of channel quality.

Certain aspects provide a network entity for wireless communications. The network entity generally includes means for transmitting a plurality of reference signals in a plurality of reference signal sounding occasions. The network entity further includes means for receiving, from, a UE, first one or more indications of first one or more reference signal sounding occasions associated with a first level of channel quality and second one or more indications of second one or more reference signal sounding occasions associated with a second level of channel quality. The network entity further includes means for transmitting to a RIS controller a third indication of a beamforming configuration for use by the RIS controller, the third indication based on the first one or more indications and the second one or more indications.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, including a reconfigurable intelligent surface (RIS), in accordance with certain aspects of the present disclosure.

FIG. 2 is a block diagram conceptually illustrating a design of an example base station (BS), user equipment (UE), and RIS, in accordance with certain aspects of the present disclosure.

FIG. 3A illustrates an example of communication blockage between wireless communication devices.

FIG. 3B illustrates an example of using a RIS to overcome impediment by obstacles between a BS and a UE, according to certain aspects of the present disclosure.

FIG. 4 illustrates an example arrangement of RIS elements, in accordance with certain aspects of the present disclosure.

FIGS. 5A and 5B illustrate an example training operation for precoding RIS elements, in accordance with certain aspects of the present disclosure.

FIG. 6 is a flow diagram illustrating example operations by a network entity, in accordance with certain aspects of the present disclosure.

FIG. 7 is a flow diagram illustrating example operations by a UE, in accordance with certain aspects of the present disclosure.

FIG. 8 illustrates an example call flow for changing precoding types, in accordance with certain aspects of the present disclosure.

FIG. 9 illustrates an example RIS beamforming configuration for a group of UEs, in accordance with certain aspects of the present disclosure.

FIG. 10 illustrates an example of multiple reference signal sounding occasions, in accordance with certain aspects of the present disclosure.

FIG. 11 illustrates example reference signal measurements corresponding to multiple sounding occasions, in accordance with certain aspects of the present disclosure.

FIG. 12 illustrates an example dataset of joint beamforming configurations of multiple UEs, in accordance with certain aspects of the present disclosure.

FIG. 13 illustrates a communications device that may include various components configured to perform operations for the techniques disclosed herein.

FIG. 14 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for transmitting, from a user equipment (UE) to a network entity (e.g., a base station (BS) or a UE), such as via a reconfigurable intelligent surface (RIS), indications of reference signal sounding occasions associated with a first level and/or a second level of channel quality. Channel quality may refer to any suitable one or more metrics, such as reference signal received power (RSRP), reference signal received quality (RSRQ), signal to noise ratio (SNR), etc. In certain aspects, such indications enable the network entity and the RIS to respectively determine a beamforming configuration (e.g., beamforming precoder), in some cases, for transmissions to a group of UEs. In certain aspects, the first level of channel quality may be a “poor” channel quality (e.g., below a threshold) and the second level of channel quality may be a “good” channel quality (e.g., above the same threshold or a different threshold higher than the threshold for poor channel quality). Though certain aspects are described with respect to good and/or poor channel quality, they may be equally applicable to any suitable first level and/or second level of channel quality.

For example, the network entity may communicate with the UE via a RIS, meaning transmissions from the network entity are reflected by the RIS to the UE. Both the network entity and the RIS may be configured to perform beamforming. To perform beamforming, each of the network entity and the RIS may use respective beamforming configurations to beamform the signal transmitted. In certain aspects, the network entity, RIS, and UE are configured to perform a beam training procedure to select an appropriate beamforming configuration for the network entity, and an appropriate beamforming configuration for the RIS, such as one that is appropriate for transmission not only to a single UE, but to a group of UEs.

In certain aspects, as part of the beam training, the network entity transmits reference signals (RSs) in M reference signal sounding occasions to the UE via the RIS, where M is a positive integer. Each reference signal sounding occasion may span a different time period. In each reference signal sounding occasion, the network entity may transmit RSs in Y different resources, where Y is a positive integer. In certain aspects, Y may be one. The Y resources may refer to different time periods and/or frequencies within each reference signal sounding occasion. The RIS may be configured to vary its beamforming configuration between each reference signal sounding occasion, and the network entity may be configured to vary its beamforming configuration between each resource within a reference signal sounding occasion.

Accordingly, each RS may be transmitted with a different combination of network entity beamforming configuration and RIS beamforming configuration. The UE measures each received RS as an indication of channel quality when using the combination of network entity beamforming configuration and RIS beamforming configuration with which the RS was transmitted. For example, upon reception, the UE measures one or more metrics (e.g., reference signal received power (RSRP)) corresponding to each of the reference signals.

After measuring each RS, the UE transmits to the network entity respective indications of the resources of reference signal sounding occasions associated with poor and good channel quality (e.g., as indicated by the metrics). The network entity may then utilize the indications to determine a suitable beamforming configuration for use by the network entity for communicating with the UE, such as by mapping an indication of a resource of a reference signal sounding occasion to a beamforming configuration used by the network entity for that resource. The network entity may further provide information to a controller of the RIS for the RIS to use a suitable beamforming configuration for communicating with the UE. For example, the network entity may indicate an index or time of the reference signal sounding occasion to the RIS controller, and the RIS controller may map the index or time to a beamforming configuration used by the RIS for that reference signal sounding occasion. The use of the beamforming configuration used by the network entity and the beamforming configuration used by the RIS for communication with the UE may together be referred to as a joint beamforming configuration.

In certain aspects, the UE indicates not only resources in reference signal sounding occasions with good channel quality (e.g., above a threshold, the top X number of reference signal sounding occasions, etc.), but also indicates resources in reference signal sounding occasions with poor channel quality (e.g., below a threshold, the worst Y number of reference signal sounding occasions, etc.). Each of X and Y may be an integer, and in certain aspects configured by the network entity, and they may have the same value or different values. In such cases, the network entity may not only be able to determine beamforming configurations for the network entity and RIS that are suitable for the UE, but may also be able to determine beamforming configurations for the network entity and RIS that are not suitable for the UE. According to one or more aspects, this information may be helpful when determining beamforming configurations for the network entity and RIS that are suitable for a plurality of UEs.

In certain aspects, a network entity may communicate via a RIS with a plurality of UEs, such as at the same time, or within a time period. In such scenarios, switching between different beamforming configurations for different UEs may be difficult due to the time it takes to switch between different beamforming configurations. Accordingly, using the techniques disclosed herein where the UE indicates resources in reference signal sounding occasions with poor channel quality, the network entity can better determine which common beamforming configuration to use for a plurality of UEs by avoiding beamforming configurations that are not feasible for successful communication with any one of the plurality of UEs.

Thus, in some cases, each of the network entity and the RIS may utilize a respective common beamforming configuration to communicate with a group of UEs, such as a group of UEs located in a given location or area. For example, two or more UEs in the group of UEs may transmit indications of resources in reference signal sounding occasions associated with poor and good channel quality. The network may identify a joint beamforming configuration (e.g., a beamforming configuration for the network entity, and also a beamforming configuration for the RIS) that provides good channel quality to the two or more UEs and avoids configurations that may lead to poor channel quality.

Using beamforming configurations, each of the network entity and the RIS may change beamforming characteristics by applying precoders to its own antenna elements. For example, the antenna elements may be precoded (e.g., beamformed) by, for example, identifying for each element a particular phase shift value, weight (e.g., amplitude gain), and/or the like (referred to as precoding values) to apply to a signal communicated (e.g., transmitted, received, reflected) by the element. The precoding may cause a signal communicated by the antenna elements to be beamformed in a particular direction, resulting in certain signal strength or interference performances. Therefore, the network entity and the RIS may identify a common direction to communicate with two or more UEs with good channel quality and signal strength.

At a high level, a RIS includes a number of elements (referred to as RIS elements), which form a surface that may be integrated into different objects such as walls, sidings, clothes, etc. The RIS elements are reconfigurable scatterers, including antennas that receive and re-radiate (e.g., reflect or refract) radio wave signals. The RIS elements may be passive (e.g., differing from antenna elements of the network entity, though both may change beamforming directions, either actively or passively). When the RIS elements are passive, no external power is required for the re-radiation, and such that the re-radiation is configurable with a phase shift for each RIS element. The RIS element may also be active, such that the re-radiation may change the amplitude in addition to the phase shift. The RIS elements may therefore perform constructive interference that resembles beamforming and re-radiate beams in certain directions from a transmitter (e.g., a UE or BS) toward a receiver (e.g., a BS or UE).

Such beamforming or precoding of the RIS elements is controlled by identifying phase shift values, or weights, to be applied to corresponding RIS elements given specific conditions of the transmitter and the receiver. In certain aspects, beamforming configuration includes precoding parameters and/or other control parameters that may affect beamforming in the RIS and the BS as precoders. By configuring the precoders, the devices involved (UE, BS, and RIS) may jointly achieve a channel or signal path for communication with good quality. The present disclosure provides techniques for identifying and configuring the signal path by managing the respective beamforming configuration in the RIS and the BS.

Although the discussions herein describe BS beamforming configuration as an example, it should be understood that the beam training procedures may be similarly applicable in cases where the BS and the UE exchange positions. For example, a UE may transmit reference signal sounding occasions to a BS via a RIS.

In certain aspects, providing feedback for all possible reference signals (e.g., channel state information (CSI) reference signal (RS)) may be resource prohibitive. For example, assuming the BS has 20 possible beamforming configurations, and the RIS has 100 possible beamforming configurations, 2000 RSs may be needed to test each possible joint beamforming configuration. Accordingly, certain aspects herein provide feedback for only a subset of the reference signals, such as an indication of which RSs (each corresponding to a resource of a reference signal sounding occasion) have good channel quality, and which RSs have poor channel quality. Accordingly, the present disclosure increases throughput in the network by reducing signaling overhead. Further, as discussed, the information can be used to use a single joint beamforming configuration for a plurality of UEs, thereby reducing latency caused by switching beamforming configurations.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

### Example Wireless Communications System

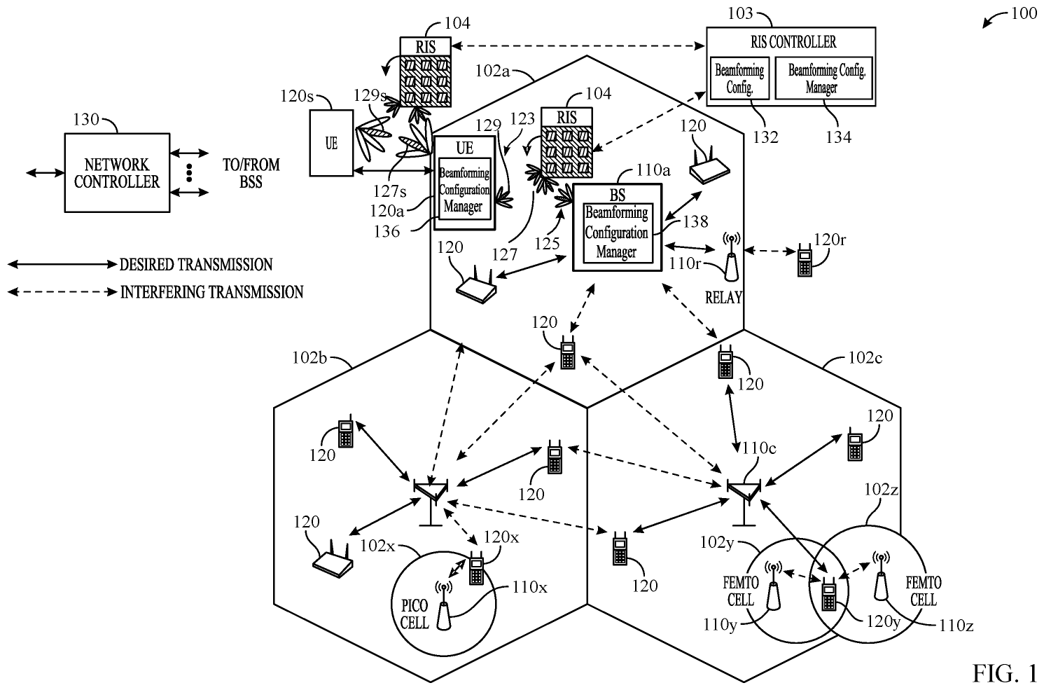

FIG. 1 illustrates an example wireless communication network 100 in which aspects of the present disclosure may be performed. For example, the wireless communication network 100 may be a New Radio (NR) or 5G network. As shown in FIG. 1, a user equipment (UE), such as the UE 120 (e.g., including the UEs 120a and 120s) in the wireless communication network 100 communicates with a serving base station (BS), such as the BS 110a in a cell 102a in the wireless communication network 100. The BS 110a may be configured with multiple beamforming configurations (e.g., antenna arrays/panels and/or beams) for downlink transmission to the UE 120a. Similarly, the UE 120a may be configured with multiple beamforming configurations for uplink transmission to the BS 110a. In some cases, the UE 120a may be configured with multiple beamforming configurations for sidelink transmission to another UE 120s.

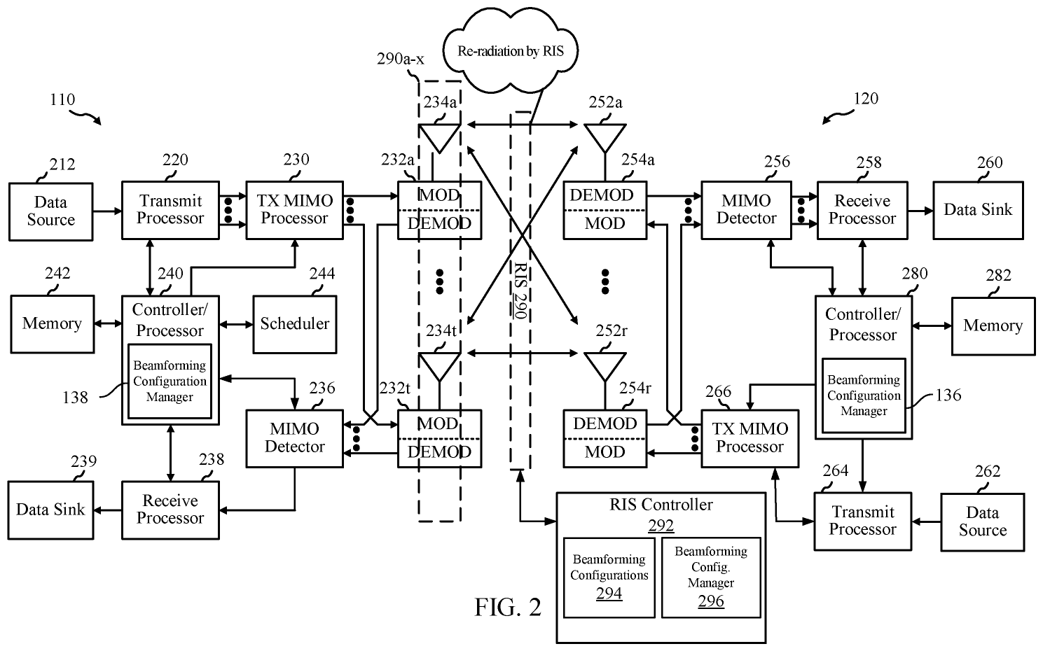

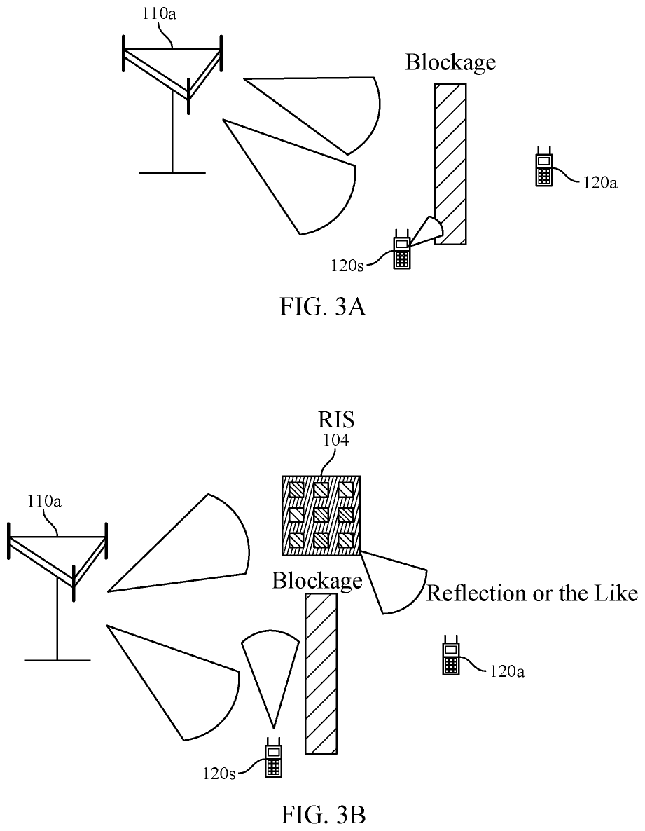

In certain aspects, communication between the BS 110a (e.g., gNB) and the UE 120a may be blocked by obstacles and require assistance from a reconfigurable intelligent surface (RIS) 104 (also shown in FIGS. 2 and 3). The RIS 104 enables communications between the BS 110a and UE 120a to be received and re-radiated, thereby avoiding the obstacles. For example, the RIS 104 may be configured with a beamforming configuration/precoding for one or more elements thereon (referred to as RIS elements) to allow abeam from one of the BS 110a and UE 120a (e.g., a transmitter) to be re-radiated off the RIS to reach the other one of the BS 110a and UE 120a (e.g., a receiver). The direction of the re-radiation by the RIS 104 may be controlled or reconfigured by the RIS controller 103 of the RIS 104.

As shown, the BS 110a may perform beamforming 125 in a range of directions. The RIS 104 may re-radiate the beams 127 in another range of directions (e.g., toward the UE 120a and around obstacles between the BS 110a and the UE 120a). Similarly, the UE 120a may perform beamforming 123 in a range of directions. One or more beams 129 may be identified as a desirable path after performing the beamforming or beam training procedure. The one or more beams 129 correspond to respective beamforming configurations in the UE 120a, the RIS 104, and the BS 110a.

The RIS controller 103 includes beamforming configurations 132 and a beamforming configuration manager 134 for configuring beamforming (e.g., applying precoding according to a precoding type, such as a codebook based precoding or a non-codebook based precoding, to the RIS elements) of the RIS 104. The beamforming configurations 132 include indications of values of weights to configure each RIS element to modify the radio signal re-radiated by each RIS element, such as weight shifting or changing amplitudes.

During beam training, the BS 110a may determine beamforming configurations, for itself as well as for the RIS 104, based on feedback from the UE 120a. For example, the BS 110a may transmit a series of reference signals (RSs) in one or more directions 129. The RSs may be transmitted in multiple reference signal sounding occasions and/or in multiple resources of each reference signal sounding occasion. The RIS 104 re-radiates the RSs toward the UE 120a. Via the re-radiation (e.g., reflection or refraction) by the RIS 104, the UE 120a receives the RSs. The re-radiation by the RIS is controlled by a RIS controller that may apply different beamforming configurations (e.g., precoding weights) to the RIS elements, for the RSs to reach the UE 120a. The UE 120a may evaluate the RSs using one or more metrics, such as a signal strength, an energy level, a signal to noise ratio (SNR), a channel quality indicator (CQI), or a reference signal received power (RSRP). The UE 120a transmits the metrics measurements to the BS 110a as the feedback.

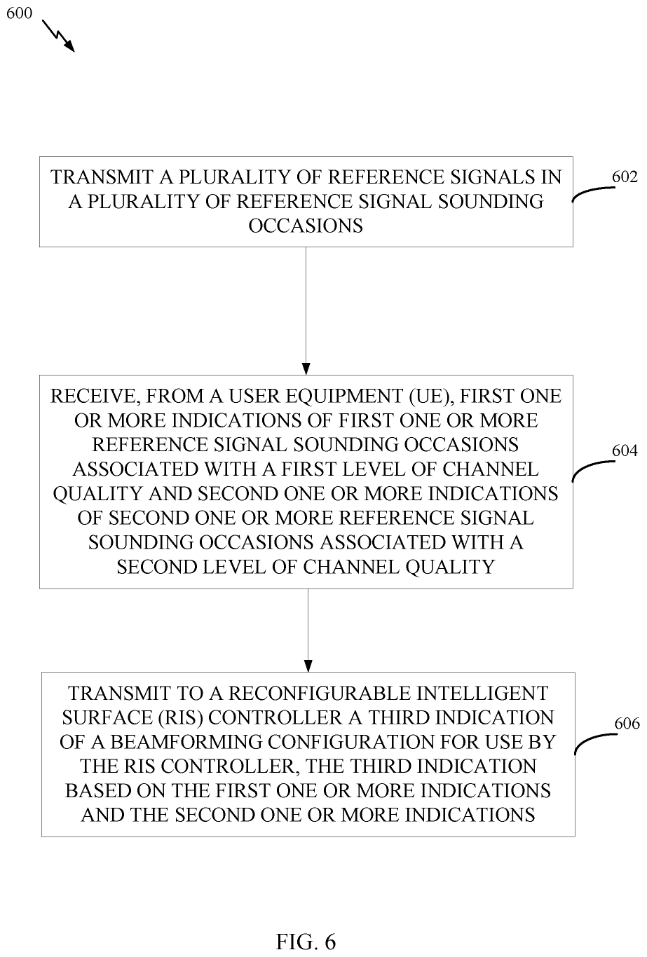

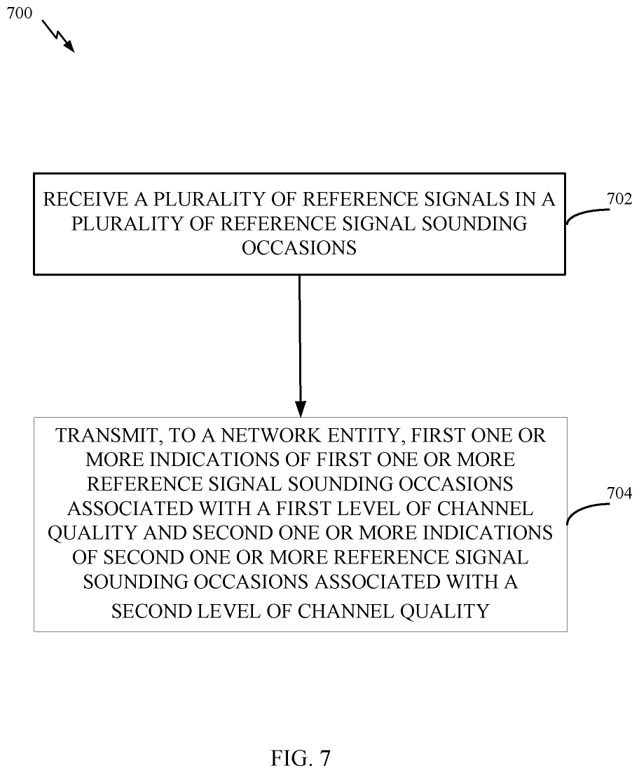

The BS 110a and the UE 120a may respectively include a beamforming configuration manager 138 and 136 for performing one or more operations discussed herein, such as operations 600 of FIG. 6 and operations 700 of FIG. 7. The respective beamforming configuration managers 136 and 138 may determine and/or generate signaling for beamforming configurations or the indices thereof associated with reference signals sounding occasions, as described in detail below.

As illustrated in FIG. 1, the wireless communication network 100 may include a number of BSs 110 and other network entities. A BS may be a station that communicates with UEs. Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120a, 120s, 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates transmissions between a UE and a serving BS, which is a BS designated to serve the UE on the downlink and/or uplink. A finely dashed line with double arrows indicates potential interfering transmissions between a UE and a BS or transmissions between the RIS controller 103 and the RIS' 104.

FIG. 2 illustrates example components of BS 110 and UE 120 (as depicted in FIG. 1), which may be used to implement aspects of the present disclosure. As shown, the RIS 290 may assist the communications, by receiving and re-radiating radio signals, between the BS 110 and UE 120, such as when such communications are impeded or blocked by obstacles (illustrated as the blockage in FIGS. 3A and 3B). For example, the RIS 290 may re-radiate the transmissions from one of the BS 110 or UE 120 to the other using reflection, refraction, or other passive or active mechanisms.

The RIS 290 may be reconfigured or controlled by a RIS controller 292. Each RIS element may re-radiate radio signals with certain phase or amplitude changes, such as phase shifts. The RIS controller 292 may reconfigure the phase or amplitude changes by applying a precoding weight to each RIS element to enable the RIS 290 to re-radiate an output beam at different directions given a particular input beam. An illustrative deployment example of the RIS 290 is shown in FIG. 3B. Although the RIS controller 292 or 103 and the RIS 290 or 104 are illustrated as a separate and independent device, in some cases, the RIS controller 292 or 103 may be integrated with each RIS 290 or 104.

According to the present disclosure, the RIS controller 292 includes a beamforming configuration manager 296 and/or beamforming configurations 294. The beamforming configuration manager 296 may select beamforming configurations based on indications of beamforming configurations received from the BS 110. For example, the BS 110 may indicate a beamforming configuration at the RIS 290 or 104 corresponding to a beamforming configuration applied at the BS 110. The RIS controller 292 may call up a set of beamforming configurations based on an index corresponding to one of the stored beamforming conjurations 294.

The antennas 252, processors 266, 258, 264, and/or controller/processor 280 of the UE 120 and/or antennas 234, processors 220, 230, 238, and/or controller/processor 240 of the BS 110 may be used to perform the various techniques and methods described herein. As shown in FIG. 2, the controller/processor 280 of the UE 120 has a beamforming configuration manager 136 that may manage transmission and reception of indices, such as time indices of reference signal sounding occasions and resource indices associated with beam training reference signals. The beamforming configuration manager 136 of the UE 120 may further provide feedback, such as channel state information (CSI) reference signal (RS) resource indicator (CRI), to the BS 110. Based on the feedback from the UE 120, the BS 110 may determine one or more beamforming configurations of the best and worst channel qualities of the sounding occasions. The BS 110 may then apply a beamforming configuration for itself (e.g., managed by the beamforming configuration manager 138) and transmit indications of a corresponding beamforming configuration for the RIS 290 to the RIS controller 292.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The processor 220 may also generate reference symbols, e.g., for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the base station 110 and may provide received signals to the demodulators (DEMODs) in transceivers 254a through 254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a through 254r (e.g., for SC-FDM, etc.), and transmitted to the base station 110.

At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The processor 240 and/or other processors and modules at the BS 110 may perform or direct the execution of processes for the techniques described herein. For example, the beamforming configuration manager 136 of the processor 280 may perform operations 600 of FIG. 6, and the beamforming configuration manager 138 of the processor 240 may perform operations 700 of FIG. 7, as described in more detail herein. The memories 242 and 282 may store data and program codes for BS 110 and ULE 120, respectively. A scheduler 244 may schedule UEs for data transmission on the downlink and/or uplink.

### Example Application and Precoding of Reconfigurable Intelligent Surface (RIS)

As discussed above, massive multiple input multiple output (MIMO) configuration increases throughput. For example, MIMO can achieve high beamforming gain by using active antenna units and can operate with individual radio frequency (RF) chains for each antenna port. To further such advantages and extend coverage, RISs may be deployed to reflect impinging waves in desired directions. In some cases, RISs may operate without substantial power consumption when they operate passively to only reflect or refract beams from the transmitter toward the receiver. In some cases, the reflection or refraction direction may be controlled by gNB or a monitoring sidelink UE.

FIG. 3A illustrates an example of communication blockage between wireless communication devices. As shown, impeded by a blockage, a first network entity (BS 110a) may only transmit to the UE 120s. Because the blockage prevents signals from reaching the UE 120a, the transmissions from the first network entity cannot reach the UE 120a. The blockage also prevents the UE 120s from establishing sidelink communications with the UE 120a. As such, the UE 120a may not communicate with the BS 110a via the UE 120s using sidelink either.

FIG. 3B illustrates an example of using a RIS 104 to overcome the blockage, according to certain aspects of the present disclosure. As shown, a RIS 104 is introduced to reflect or otherwise re-radiate the radio signals to bypass the blockage. For example, the two-way communications between the BS 110a and the UE 120a are enabled by the RIS 104 re-radiating one or more beams from the BS 110a toward UE 120a and vice versa. Furthermore, the RIS 104 can also be reconfigured, such as with different precoding values, to enable the UEs 120s and 120a to establish sidelink communications.

The RIS 104 may perform passive beamforming. For example, the RIS 104 may receive signal power from the transmitter (e.g., the BS 110a, UE 120a, or UE 120s) proportional to the number of RIS elements thereon. When the RIS 104 reflects or refracts the radio signal, the RIS elements cause phase shifts to perform conventional beamforming or precoding. The phase shifts are controlled by precoding weights (e.g., a multiplier or an offset of time delay) applied to the RIS elements. For an array of RIS elements, such as an m×n rectangular matrix, for example, a respective precoding weight may be generated or specified for each of the RIS element by the RIS controller. As the relative positions of the ULE 120a, the BS 110a and the RIS 104 may vary, the beamforming at the BS 110a and the UE 120a may also be configured, along with the reconfiguration at the RIS 104, to realize a signal path of an optimal signal strength. For example, the BS 110a and the UE 120a may have respective antenna arrays to form beams at different directions.

### Example RIS Beamforming Configuration

The present disclosure provides techniques for reconfigurable intelligent surface (RIS) beamforming configuration, by transmitting, from a user equipment (UE) to a network entity via a RIS, indications of reference signal sounding occasions associated with good and/or poor channel quality. The procedure conducted to obtain a desired beamforming configuration may be referred to as training. For example, the network entity may first transmit a number of reference signals in multiple reference signal sounding occasions to the UE. For each of the multiple reference signal sounding occasions, a corresponding reference signal may be transmitted over corresponding one or more resources (e.g., in time and/or frequency). The UE measures each received reference signal by a performance metric as an indication of channel quality. The UE transmits the measurements to the network entity for determining and applying a beamforming configuration on the RIS. The network entity may then transmit the beamforming configuration to the RIS controller to configure the RIS.

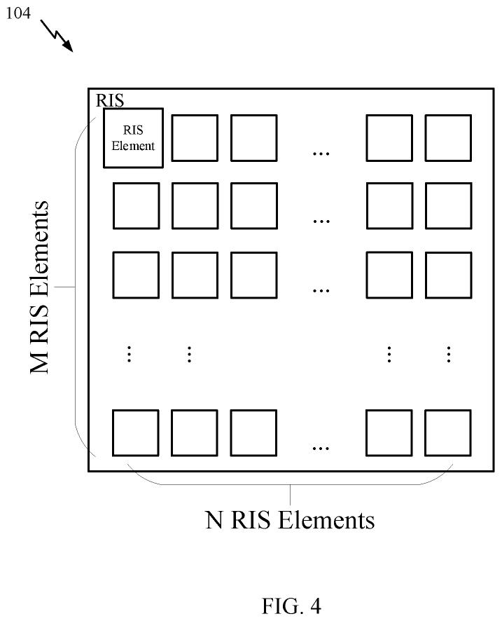

The beamforming configuration may include settings and precoding parameters for each RIS element of the RIS 104. An example of an array of N×M RIS elements is shown in FIG. 4. When a specific beamforming configuration is to be applied to a RIS, the RIS controller may apply different precoding weights to the RIS elements (or at least a subset thereof), such that the beam direction of re-radiation may be altered. In one example, the RIS controller may generate or select a precoder matrix of size N×M, where Nis the number of horizontal elements and M is the number of vertical elements. Although FIG. 4 illustrates the RIS as a rectangular array, the disclosed precoding techniques herein are applicable to RIS of various element layouts or patterns. The beamforming configuration may refer to any change to the RIS 104 that alters beamforming characteristics.

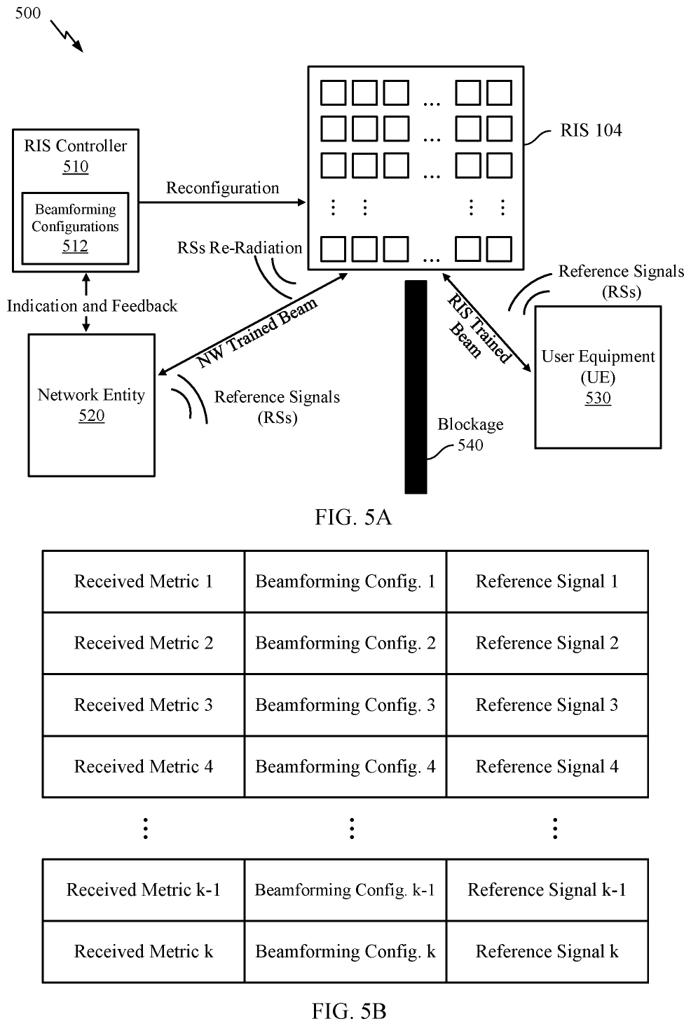

FIGS. 5A and 5B illustrate an example training operation 500 for precoding RIS elements. As shown in FIG. 5A, a network entity 520 (e.g., the base station 110a or the sidelink UE 120s of FIG. 3A) may be blocked by the blockage 540 from communicating directly with a UE 530, which may be within a UE group. The UE group may include two or more UEs adjacent to each other or within certain directional proximity.

During training, as shown in FIG. 5A, the network entity 520 may transmit reference signals re-radiated by the RIS 104 to reach the UE 530, regardless if the reference signals would be blocked by the block 540. In response to receiving the reference signals, the UE 530 sends the network entity 520 feedback of corresponding received metrics. The network entity 520 may determine a desired beamforming configuration based on the feedback. For example, the feedback of a received metric (e.g., RSRP) may be associated with an index of a beamforming configuration. The network entity 520 receiving the feedback may indicate to the RIS controller 510 of the index corresponding to the received metric that satisfies certain predefined criteria, such as the received metric being within a range of top percentile.

In certain aspects, the RIS controller 510 may store and/or apply different beamforming configurations 512 to the RIS elements. The different beamforming configurations may correspond to different reference signal sounding occasions. As such, the RIS controller 510 may use an index identifying one of the reference signal sounding occasions to ascertain the corresponding beamforming configuration.

In the downlink direction, the network entity 520 transmits a plurality of reference signals to the RIS 104. Each RS may be transmitted during an RS sounding occasion (e.g., a resource set in which an RS is transmitted) and have an associated index that identifies the RS based on the RS occasion in which it is transmitted. The RIS 104 re-radiates, in a different beam direction (than the direction of the transmission of the network entity 520), the RSs to the UE 530. Upon receiving the RSs, the UE 530 may provide indication and/or feedback to the network entity 520. The network entity 520 then identifies a desired beamforming configuration for the RIS 104 and transmits an indication of an index corresponding to the beamforming configuration to the RIS controller 510, in order to alter or update the beamforming configuration for the RIS 104.

The network entity 520 may transmit indications of the beamforming configuration to the RIS controller 510 after the network entity 520 determines beamforming configurations that provide reliable channel quality. For example, an indication of one or more indices of one or more RSs that have the best (e.g., highest) measured metrics (e.g., a signal strength, an energy level, a signal to noise ratio (SNR), a channel quality indicator (CQI), or a reference signal received power (RSRP)) may be used to associate with the desired beamforming configuration. The RIS controller 510 may use the beamforming configuration associated with the best measured metrics on the RIS 104.

The training operation may similarly be performed in the uplink direction. For example, the UE 530 may also transmit RSs via the RIS 104 to the network entity 530. The uplink RSs may similarly be transmitted in multiple RS sounding occasions indexed by time indices. Each downlink RSs may include one or more RS indexed by resource indices. The RIS 104 re-radiates the RSs to the network entity 520. Upon receiving the RSs, the network entity 520 measures one or more metrics characterizing the channel quality, such as SNR, CQI, RSRP, or the like. The network entity 520 may then provide feedback to the UE 530. The UE 530 may transmit indications to the RIS controller 510 based on the feedback, in order to alter or update the precoding settings in search for an optimal precoding configuration for the RIS 104.

As shown in FIG. 5B, a number of k reference signals corresponding to k reference signal sounding occasions (e.g., indices 1, 2, 3, . . . , k) are used to transmit RSs. After receiving the reflected RS signals, the UE 530 measures a metric (i.e., the k received metrics) for each RS. At the end of the training, the UE 530 may transmit the index corresponding to the RS sounding occasion or the RS having a best (e.g., highest) measured metric to the network entity 520. As such, the index identifying the best received metric may be used to identify the corresponding best beamforming configuration for the RIS 104. The network entity 520 may indicate the index to the RIS controller 510 to apply the corresponding beamforming configuration.

### Example Feedback Indicating Best and Worst Beamforming Configurations

FIG. 6 is a flow diagram illustrating example operations 600 for wireless communication, in accordance with certain aspects of the present disclosure. The operations 600 may be performed by a device transmitting reference signals (RSs) in RS sounding occasions. In certain aspects, when configuring a reconfigurable intelligent surface (RIS) for a group of UEs, the device may be a network entity, such as a gNB or the BS 110 of FIG. 1. In some cases, in view of FIGS. 3B and 5A together, other devices may take place of the network entity, such as the sidelink UE 120s.

Operations 600 may be implemented as software components that are executed and run on one or more processors (e.g., controller/processor 240 of FIG. 2). Further, the transmission and reception of signals by the network entity in operations 800 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals.

The operations 600 begin, at 602, by transmitting a plurality of reference signals in a plurality of reference signal sounding occasions. For each of the plurality of reference signal sounding occasions, a corresponding reference signal is transmitted over corresponding one or more resources. For example, in one reference signal sounding occasion, two or more reference signals may be transmitted in two or more resources. In some cases, the resources correspond to different frequencies, different times, or both.

At 604, the network entity receives, from a UE (e.g., a first UE of a group of UEs), first one or more indications of first one or more reference signal sounding occasions associated with a first level (e.g., poor or below certain thresholds) of channel quality and second one or more indications of second one or more reference signal sounding occasions associated with a second level (e.g., good or above certain thresholds) of channel quality. For example, the first one or more indications may include time indices of the reference signal sounding occasions resulting in low measurement metric (e.g., RSRP) at the UE. The second one or more indications may include time indices of the reference signal sounding occasions resulting in high measurement metric.

By having one or more indications of the poor channel quality from the UE, the network entity may avoid the corresponding beamforming configurations when determining a beamforming configuration to apply to the network entity and the RIS for the UE and a group of two or more UEs including the UE. Similarly, by having one or more indications of the good channel quality from the UE, the network entity and the RIS may respectively apply a beamforming configuration for two or more UEs based on respective indications of good channel quality. The beamforming configuration may be selected from existing configurations commonly indicated by the two or more UEs, or computed or determined by interpolation, extrapolation, or other computation techniques, based on datasets constructed based on the one or more indications from the two or more UEs.

At 606, the network entity transmits to a RIS controller a third indication of a beamforming configuration for use by the RIS controller. The third indication is based on the first one or more indications and the second one or more indications. For example, the network entity may determine the third indication of the beamforming configuration based on the one or more indications from the UE (and in cases of a group of UEs, from another UE). The RIS controller may (re)configure the RIS using the beamforming configuration until the next reconfiguration.

FIG. 7 is a flow diagram illustrating example operations 700 for wireless communication, in accordance with certain aspects of the present disclosure. The operations 700 may be performed by a UE, such as the UE 120 of FIGS. 1 and 2. Operations 700 may be performed complementary to operations 600, together with a RIS.

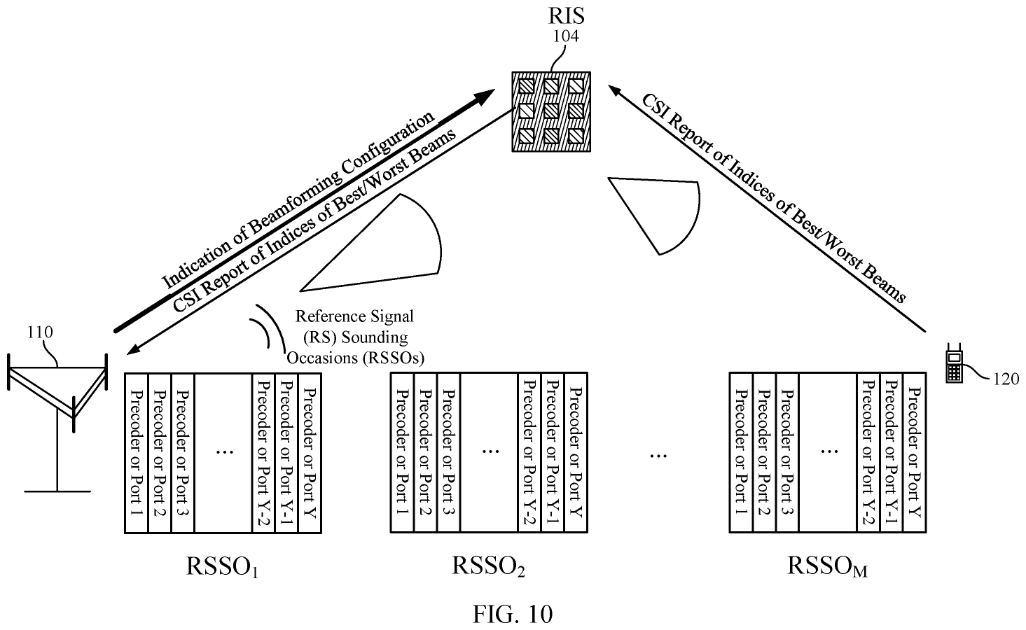

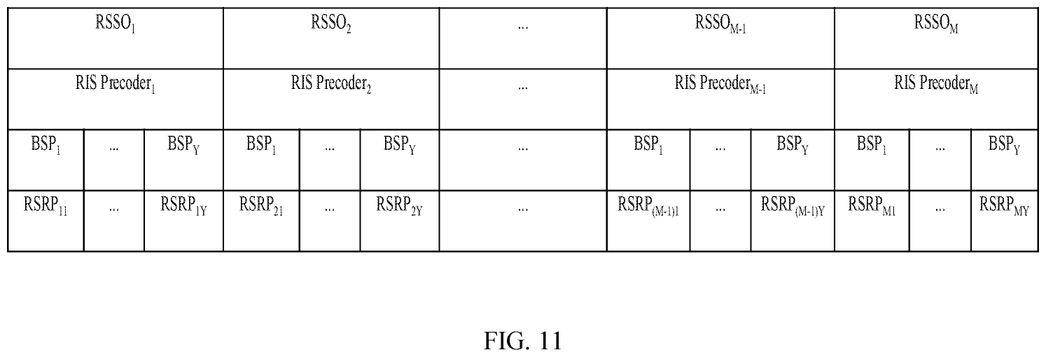

The operations 700 begin, at 702, by receiving two or more reference signals in two or more reference signal sounding occasions. For each of the plurality of reference signal sounding occasions, a corresponding reference signal is received over corresponding one or more resources. For example, The UE receives multiple reference signals from the network entity via the RIS. The total number of the multiple reference signals may equal to the number of resources each carrying a corresponding reference signal times the number of sounding occasions, as illustrated in FIGS. 10-11. By identifying channel quality using a metric, such as RSRP or SNR, the UE may determine the channel quality corresponding to each reference signal.

At 704, operations 700 continue by transmitting, to a network entity, first one or more indications of first one or more reference signal sounding occasions associated with a first level of (e.g., poor) channel quality and second one or more indications of second one or more reference signal sounding occasions associated with a second level of (e.g., good) channel quality.

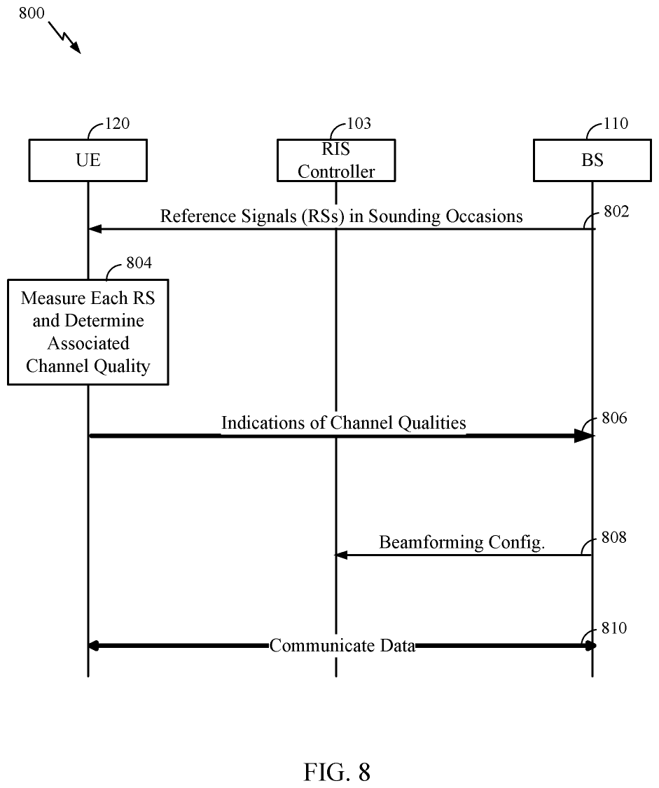

An example of details of operations 600 and 700 is further illustrated in the call flow diagram 800 in FIG. 8, which shows example signaling and operations of the UE 120, the RIS controller 103, and the BS 110.

At 802, the BS 110 transmits multiple reference signals (RSs) in multiple RS sounding occasions. Each of the multiple RS sounding occasions may include multiple resources for transmitting multiple RSs, for example, a corresponding RS is transmitted over a corresponding resource.

Upon receiving the RSs, at 804, the UE 120 measures each RS to determine a channel quality (e.g., RSRP) associated with the RS. In some cases, the BS 110 may configure a threshold defining the poor channel quality (e.g., measurement value, or ranking) and a threshold defining the good channel quality. In some cases, the BS 110 may configure in the UE 120 a number of RSs for which to provide feedback to the BS 110.

At 806, the UE 120 transmits to the BS 110 one or more indications of RSs associated with poor channel quality and good channel quality. For example, the indications may indicate reference signal sounding occasions used for communicating the RSs. In some cases, the indications may further indicate particular resources used for communicating the RSs in the reference signal sounding occasions. Based on the indications, such as by ranking the ULE metric measurements, the BS 110 may determine one or more best/good joint beamforming configurations and one or more worst/poor joint beamforming configurations for the RIS and itself. In some cases, the BS 110 may receive one or more indications of RSs associated with poor channel quality and good channel quality from another UE. The BS 110 may then determine one joint beam configuration that provides good channel quality to both UEs, if available.

At 808, the BS 110 transmits an indication of the determined beamforming configuration to the RIS controller 103 for configuring the RIS. For example, indication may be a time index of a reference signal sounding occasion selected as having the appropriate beamforming configuration for the RIS, which the RIS maps to the appropriate beamforming configuration. The RIS controller 103 then applies the precoding according to the beamforming configuration.

With the RIS configured according to the beamforming configuration, at 810, the UE 120 communicates data with the BS 110 via the trained RIS 104.

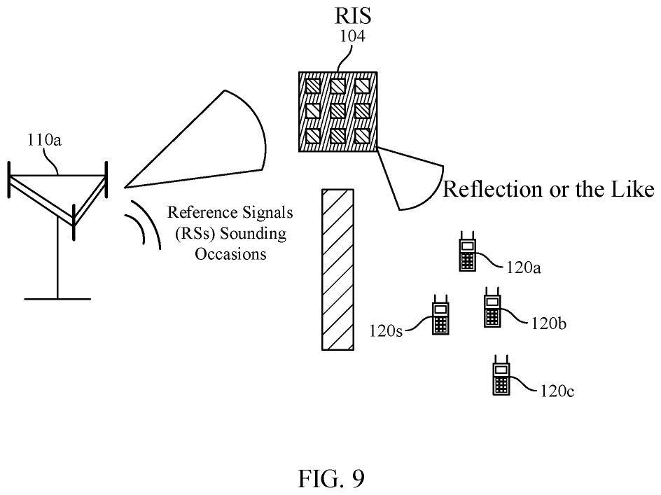

FIG. 9 illustrates an example RIS beamforming configuration for a group of UEs, in accordance with certain aspects of the present disclosure. As shown, multiple UEs 120a-c and UE 120s may all be blocked from direct communication with the BS 110a and rely on the RIS 104. Although the RIS 104 may be trained specific to each of the UEs 120a-c and UE 120s, such as identifying specific precoding weights that maximizes signal strength at a specific UE, reconfiguring the RIS 104 for each UE may be inefficient and unnecessary. For example, if some of the UEs 120a-c are adjacent to each other, the same beamforming configuration at the RIS 104 and the BS 110a may provide sufficient signal strength to the group of UEs. The present disclosure provides methods and techniques in signaling multiple indications of good and poor channel quality from each UE to the BS 110a, such that the BS 110a may determine a joint beam configuration and transmits the corresponding precoding configuration to the RIS 104, as shown in FIGS. 10-12.

FIG. 10 illustrates an example of multiple reference signal sounding occasions (RSSOs from 1 to M), in accordance with certain aspects of the present disclosure. As shown, there are MRS sounding occasions used for transmitting RSs from the BS 110 to the UE 120 via the RIS 104. The indices 1 through M may be referred to as time indices or indexes of reference signal sounding occasions. M is an integer and may be determined by the BS 110. M may be determined based on an expectation for the sounding procedure to identify beamforming configurations to achieve good channel quality.

In each RS sounding occasion, multiple reference signals may be transmitted in multiple resources, the multiple resources may be indexed from 1 through Y as shown. Y is an integer and may be determined by the BS 110 based on resource availability. The reference signals 1 through Y may correspond to different precoder or precoding settings, or may refer to different ports (described further herein), at the BS 110 (referred to as “Precoder or Port #” as shown). FIG. 10 illustrates the multiple reference signals transmitted in different time resources (e.g., at different slot locations), while in other examples, the multiple reference signals may be transmitted using different frequency resources (e.g., at different subcarrier locations) or a combination of different time and frequency resources.

In response to the sounding occasions, the UE 120 may transmit, to the BS 110 via the RIS 104, channel state information (CSI) report of the indices corresponding to a number of best and worst resource/sounding occasions measured at the UE 120. The BS 110 may use the CSI report to identify the associated best and worst beam configurations. For example, based on the time indices and resource indices, each corresponding RSRP measurement at the UE 120 may be associated with a beamforming configuration corresponding to the indices, as shown in FIG. 11. The BS 110, upon identifying the index of a beamforming configuration based on the indications in the CSI report, may then transmit to the RIS controller an indication of the beamforming configuration.

FIG. 11 illustrates example reference signal measurements corresponding to multiple sounding occasions, in accordance with certain aspects of the present disclosure. Complementary to the example shown in FIG. 10, FIG. 11 shows the M reference signal sounding occasions RSSO₁ through RSSO_{1 . . . M}, in which the BS 110 transmits RSs to the UE 120. Each of the RSSO₁ . . . M has a corresponding RIS beamforming configuration (e.g., precoder setting) indexed as RIS Precoder₁ through RIS Precoder _{M}. In each RSSO, there are Y resources used for transmitting RSs. As shown, each resource corresponds to a BS Precoder (BSP) 1 through Y used by the BS 110 to transmit the RSs. Each of the BSP_{1 . . . Y} corresponds to a beamforming configuration at the BS 110.

Upon receiving the reference signals, the UE 120 measures a metric characterizing the channel quality. The metric may be RSRP as shown, which is indexed by a two-dimensional index: from 11 to M Y. In some cases, the UE 120 may rank the RSRP₁₁, RSRP₁₂, . . . , RSRP_{M1}, RSRP_{M2}, RSRP_{M(Y-1)}, and RSRP_{MY}, and transmit a subset thereof, corresponding to the best and the worst channel conditions, as feedback to the BS 110. The BS 110 may use the subset of the feedback RSRPs to identify the corresponding beamforming configurations based on the indices of resources/sounding occasions. As the RSRP_{11 . . . MY} include both time and resources indices for respective BS and RIS beamforming configurations, the feedback RSRPs may be referred to as joint beamforming configuration.

The BS 110 may request the subset of the feedback RSRPs from the UE 120. For example, the BS 110 may configure a threshold that defines good channel quality and a threshold that defines poor channel quality. Alternatively, the BS 110 may configure a number of a subset of RSRPs of good channel quality by ranking and a number of a subset of RSRPs of poor channel quality by ranking. The UE 120 transmits indications of the subset of RSRPs to the BS 110 according to the set threshold or number.

Because each RSRP_{11, . . . , MY} is associated with respective time indices (1 through M) and resource indices (1 through Y) as shown, the indices of the feedback RSRPs can be used by the BS 110 to ascertain the corresponding beamforming configurations (e.g., RIS Precoder and BS Precoder) to be used by the BS 110 and RIS controller.

In certain aspects, the RIS's surface beams are transparent to the BS 110, meaning the BS 110 does not know what beamforming configuration the RIS is using for a given reference signal sounding occasion. Upon receiving the feedback RSRPs from the UE 120, the BS 110 may use the time indices (1 through M) to indicate to the RIS controller to use a corresponding beamforming configuration.

In some cases, the UE 120 may transmit the subset of RSRPs to the BS 110 in a CSI-RS resource indicator (CRI). For example, the UE 120 transmits a number of CRIs corresponding to a number of the best or the worst RSRP measurements. In an example, K CRIs are used to transmit the best K RSRP measurements, and L CRIs are used to transmit the worst L RSRP measurements. K and L are integers configured by the BS 110 via radio resource control (RRC) or media access control (MAC) control element (CE). In some cases, the BS 110 does not configure specific values for K or L, but instead, provides a respective threshold values for RSRPs indicating good channel quality and poor channel quality. The UE 120 may identify the subset of RSRP using the threshold values and transmit the K CRIs and L CRIs accordingly.

In some cases, the BS 110 may configure Y=1. That is, a single resource for one reference signal is used in each sounding occasion. As such, the feedback RSRPs may be simplified as RSRP₁, RSRP₂, . . . RSRP_{M}.

In some cases, Y is greater than 1. Multiple resources in each sounding occasion are used for multiple corresponding reference signals. The feedback RSRPs may include both time indices and resource indices as discussed above.

In some cases, the BS 110 may transmit reference signals (e.g., CSI-RS) in the reference signal sounding occasions for port selection. For example, the UE 120 may signal to the BS 110 the best K ports and the worst L ports in the feedback. For example, the Y resources in each reference signal sounding occasions may have the resource indices indicate the corresponding ports at the BS 110. As such, the feedback may include the best K ports of the BS 110 as indicated by the resource indices and the corresponding RIS beamforming configuration as indicated by the time indices. Similarly, the feedback may include the worst L ports of the BS 110 as indicated by the resource indices and the corresponding RIS beamforming configuration as indicated by the time indices. Such port selection technique using the resource indices may be performed either when the RIS's surface beams are transparent to the BS 110 or when the RIS's surface beams are known at the BS 110. In certain aspects, a port refers to an antenna port of the BS 110 (or in another example RIS 104). An antenna port may not correspond to a physical antenna, but rather a logical entity that represents a beamforming configuration and/or a set of physical antennas used for communication. For example, each antenna port may be distinguished by its reference signal sequence. Thus, the beams of BS 110 or RIS 104 in FIG. 1, or the beam configuration shown in in FIG. 5B may be visual representations related to an antenna port. More specifically different combinations of antennas 234a-234t of BS 110 for transmission may be referred to as different antenna ports 290a-x.

In certain aspects, the RIS's surface beams are known at the BS 110, meaning the BS 110 knows the RIS beamforming configuration the RIS is using for a given reference signal sounding occasion. The BS 110 can configure one or more resources of reference signals (BSP₁, BSP₂, . . . , BSP_{Y}) in each sounding occasion (RSSO₁ through RSSO_{M}) to sound the UE 120 for M*Y resources. The UE 120 may provide feedback to the BS 110 in similar manners discussed above.

In certain aspects, the feedback transmitted from the UE 120 to the BS 110 (e.g., CRIs) may collide with another uplink transmission, such as physical uplink control channel (PUCCH). If collisions are expected to occur, the UE 120 may reduce the number of the subset RSRP feedback to avoid such collisions by reducing the number of symbols needed to transmit the feedback to the BS 110. Referring to the above example of K and L CRIs, the UE 120 may update the transmission of the best K CRIs and the worst L CRIs by dropping indications from the best K CRIs and the worst L CRIs until the remaining feedback to be transmitted are below a threshold size. The threshold size may be determined based on the potential collision with the PUCCH. In some cases, the UE 120 may drop the L CRIs first, before dropping any K CRIs. In some cases, the UE 120 may drop the K CRIs and the L CRIs in turn. Three example options are provided below.

In a first option, the number of K and L CRIs may be reduced or dropped equally. In addition, when dropping one or more of the K CRIs, the one(s) having the lowest corresponding RSRP ranking in good channel quality than the other K CRIs would be dropped first. Similarly, when dropping one or more of the L CRIs, the one(s) having the highest corresponding RSRP ranking in good channel quality than others (i.e., the one(s) providing better channel quality than the other L CRIs) would be dropped first.

In a second option, the L CRIs will be dropped first, starting with the one(s) having the highest corresponding RSRP ranking in good channel quality than the other L CRIs, before dropping any K CRIs.

In a third option, similar to the second option, the L CRIs will be dropped first but the last L CRI indicating the worst channel quality will remain to be transmitted as feedback. If additional CRIs need be dropped to avoid collisions, then among the K CRIs having the lowest corresponding RSRP ranking in good channel quality than the other K CRIs would be dropped first.

As such, in the first and the third option, at least one K CRI and one L CRI respectively indicating the best and the worst channel quality will remain, while in the second option, at least one K CRI indicating the best channel quality will remain.

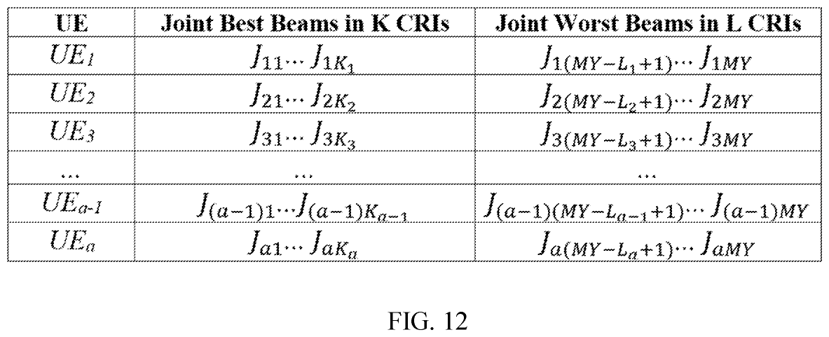

FIG. 12 illustrates an example dataset of joint beamforming configurations of multiple UEs, in accordance with certain aspects of the present disclosure. The dataset of FIG. 12 compliments the examples discussed in FIGS. 10-11 in multiple UE situations. As shown, the BS 110 may receive indications of beamforming configurations (e.g., K and L CRIs) from a group of multiple (a number of a) UEs (UE_{1, . . . , a}). For each UE, the UE 120 may rank the RSRP measurements by channel quality from J₁ through J_{MY}, and transmits a subset thereof to the BS 110, such as, the best K CRIs and the worst L CRIs as discussed above. When there are two or more UEs (i.e., a being greater than 1), the BS 110 receives corresponding multiple feedback indications from the two or more UEs (e.g., J₁₁, J₂₁, J₁₂, J₂₂, J₁₃, J₂₃, . . . J_{1MY}, J_{2MY}).

Based on the joint beamforming configurations indicated in the best K CRIs and the worst L CRIs, the BS 110 may identify at least one common joint beamforming configuration for the BS 110 and the RIS, if available, to provide good channel quality to the group of UEs. For example, the BS 110 may select from time and resource indices common in the K CRIs associated with good channel quality, and avoid selecting from time and resource indices common in the L CRIs associated with poor channel quality.

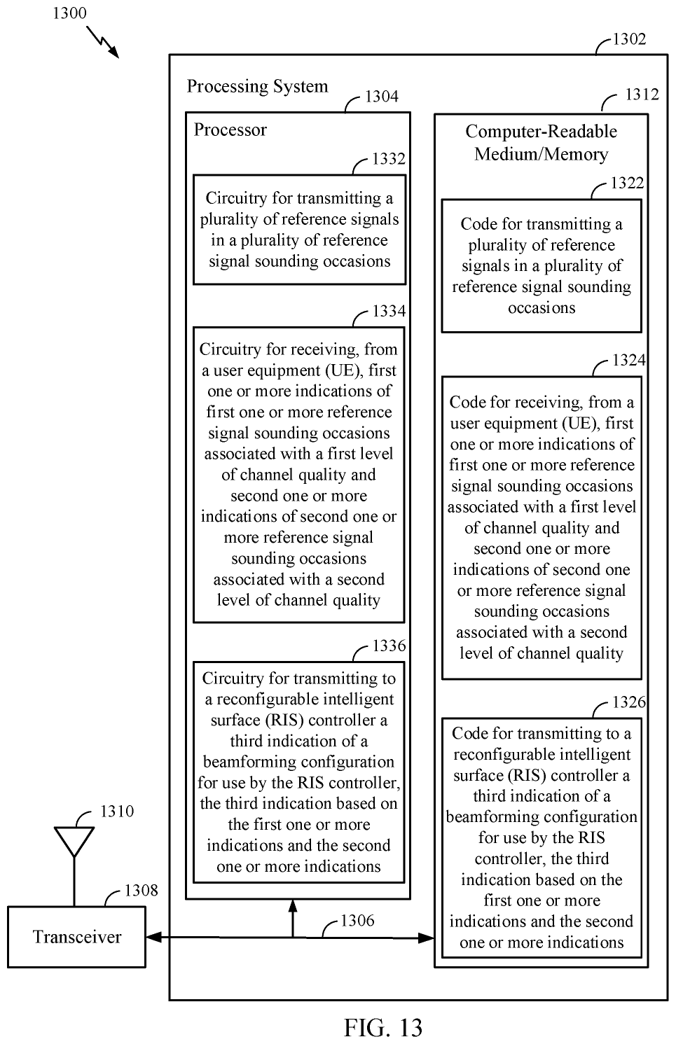

FIG. 13 illustrates a communications device 1300 that may include various components (e.g., corresponding to means-plus-function components) configured to perform operations for the techniques disclosed herein, such as the operations illustrated in FIG. 6. The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 6, or other operations for performing the various techniques discussed herein for indicating precoding types for antenna elements. In certain aspects, computer-readable medium/memory 1312 stores code 1322 for transmitting a plurality of reference signals in a plurality of reference signal sounding occasions; code 1324 for receiving, from a UE, first one or more indications of first one or more reference signal sounding occasions associated with a first level of channel quality and second one or more indications of second one or more reference signal sounding occasions associated with a second level of channel quality; and code 1326 for transmitting to a RIS controller a third indication of a beamforming configuration for use by the RIS controller, the third indication based on the first one or more indications and the second one or more indications.

In certain aspects, the processor 1304 has circuitry configured to implement the code stored in the computer-readable medium/memory 1312. The processor 1304 includes circuitry 1332 for transmitting a plurality of reference signals in a plurality of reference signal sounding occasions; circuitry 1334 for receiving, from a UE, first one or more indications of first one or more reference signal sounding occasions associated with a first level of channel quality and second one or more indications of second one or more reference signal sounding occasions associated with a second level of channel quality; and circuitry 1336 for transmitting to a RIS controller a third indication of a beamforming configuration for use by the RIS controller, the third indication based on the first one or more indications and the second one or more indications.

In certain aspects, means for transmitting (or means for outputting for transmission) may include a transmitter and/or an antenna(s) 234 or the BS 110a or the transmitter unit 254 and/or antenna(s) 252 of the UE 130a illustrated in FIG. 2, circuitry 1332 for transmitting a plurality of reference signals in a plurality of reference signal sounding occasions, wherein for each of the plurality of reference signal sounding occasions a corresponding reference signal is transmitted over corresponding one or more resources, and/or circuitry 1336 for transmitting to a reconfigurable intelligent surface (RIS) controller a third indication of a beamforming configuration for use by the RIS controller based on the first one or more indications and the second one or more indications of the communication device 1300 in FIG. 13.

Means for receiving (or means for obtaining or means for measuring) may include a receiver and/or an antenna(s) 234 of the BS 110a or a receiver and/or antenna(s) 252 of the UE 130a illustrated in FIG. 2, means for receiving, from a second UE, first one or more indications of first one or more reference signal sounding occasions of the second UE associated with a first level of channel quality and second one or more indications of second one or more reference signal sounding occasions of the second UE associated with a second level of channel quality, and/or circuitry 1334 for receiving, from a user equipment (UE), first one or more indications of first one or more reference signal sounding occasions associated with a first level of channel quality and second one or more indications of second one or more reference signal sounding occasions associated with a second level of channel quality of the communication device 1300 in FIG. 13.

Means for communicating may include a transmitter, a receiver or both. Means for generating, means for performing, means for determining, means for taking action, means for determining, means for coordinating, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 130a illustrated in FIG. 2 and/or the processing system 1302 of the communication device 1300 in FIG. 13.

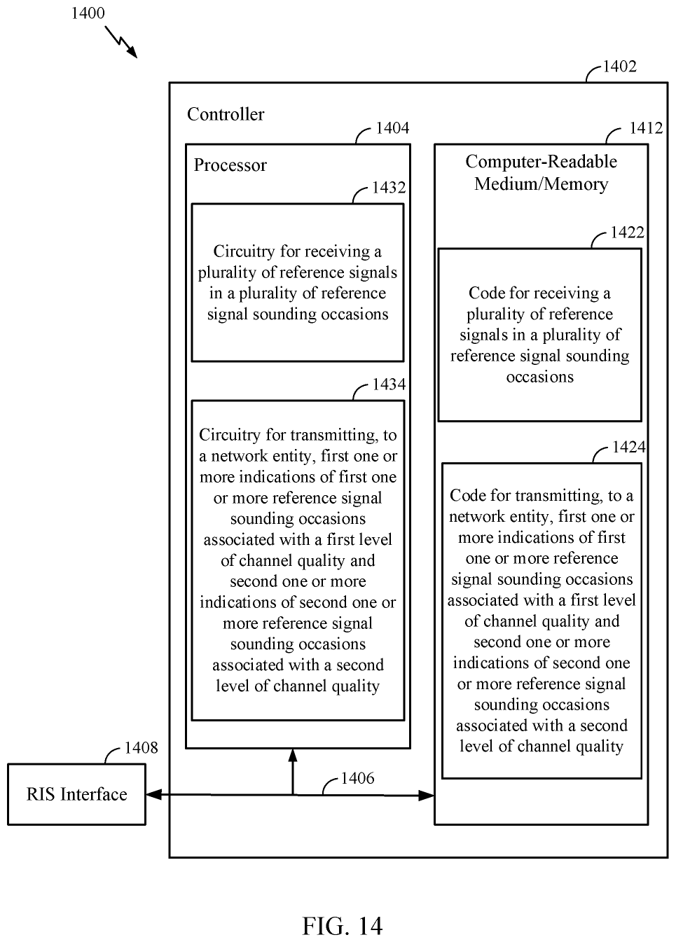

FIG. 14 illustrates a communications device 1400 that may include various components (e.g., corresponding to means-plus-function components) configured to perform operations for the techniques disclosed herein, such as the operations illustrated in FIG. 7. The communications device 1400 includes a processing system 1402 coupled to a RIS interface 1408 (e.g., a reconfigurable signal reflector or refractor). The RIS interface 1408 is configured to reflect, relay, or otherwise pass on signals for the communications device 1400, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 7, or other operations for performing the various techniques discussed herein for Indicating precoding types for antenna elements. In certain aspects, computer-readable medium/memory 1412 stores code 1422 for receiving a plurality of reference signals in a plurality of reference signal sounding occasions; and code 1424 for transmitting, to a network entity, first one or more indications of first one or more reference signal sounding occasions associated with a first level of channel quality and second one or more indications of second one or more reference signal sounding occasions associated with a second level of channel quality.

In certain aspects, the processor 1404 has circuitry configured to implement the code stored in the computer-readable medium/memory 1412. The processor 1404 includes circuitry 1432 for receiving a plurality of reference signals in a plurality of reference signal sounding occasions; and circuitry 1434 for transmitting, to a network entity, first one or more indications of first one or more reference signal sounding occasions associated with a first level of channel quality and second one or more indications of second one or more reference signal sounding occasions associated with a second level of channel quality.

In certain aspects, means for transmitting (or means for outputting for transmission) may include a transmitter and/or an antenna(s) 234 or the BS 110a or the transmitter unit 254 and/or antenna(s) 252 of the UE 120a illustrated in FIG. 2, circuitry 1434 for transmitting, to a network entity, first one or more indications of first one or more reference signal sounding occasions associated with a first level of channel quality and second one or more indications of second one or more reference signal sounding occasions associated with a second level of channel quality of the communication device 1400 in FIG. 14. Means for receiving (or means for obtaining or means for measuring) may include a receiver and/or an antenna(s) 234 of the BS 110a or a receiver and/or antenna(s) 252 of the UE 120a illustrated in FIG. 2, and/or circuitry 1432 for receiving a plurality of reference signals in a plurality of reference signal sounding occasions of the communication device 1400 in FIG. 14.

Means for communicating may include a transmitter, a receiver or both. Means for determining, means for generating, means for performing, means for taking action, means for coordinating, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2, and/or the circuitry 1434 for precoding the one or more antenna elements based on the indication indicating the at least one precoding type, and/or the processing system 1402 of the communication device 1400 in FIG. 14.

### Example Aspects

Aspect 1: A method for wireless communications by a network entity, the method comprising: transmitting a plurality of reference signals in a plurality of reference signal sounding occasions; receiving, from a user equipment (UE), first one or more indications of first one or more reference signal sounding occasions associated with a first level of channel quality and second one or more indications of second one or more reference signal sounding occasions associated with a second level of channel quality; and transmitting to a reconfigurable intelligent surface (RIS) controller a third indication of a beamforming configuration for use by the RIS controller, the third indication based on the first one or more indications and the second one or more indications.

Aspect 2: The method of Aspect 1, wherein the first one or more indications comprise first one or more indexes of the first one or more reference signal sounding occasions, and wherein the second one or more indications comprise second one or more indexes of the second one or more reference signal sounding occasions.

Aspect 3: The method of Aspect 2, further comprising transmitting, to the LIE, a configuration of a number of first one or more indexes and a number of second one or more indexes to communicate to the network entity.

Aspect 4: The method of any one of Aspects 1 to 3, further comprising transmitting, to the UE, a configuration of a first threshold defining the first level of channel quality and a second threshold defining the second level of channel quality.

Aspect 5: The method of any one of Aspects 2 to 4, wherein: for each of the plurality of reference signal sounding occasions, multiple reference signals are transmitted over a plurality of time resources; the first one or more indications further comprise third one or more indexes of one or more time resources of each of the first one or more reference signal sounding occasions, and the second one or more indications further comprise fourth one or more indexes of one or more time resources of each of the second one or more reference signal sounding occasions.

Aspect 6: The method of any one of Aspects 1 to 5, wherein for each of the plurality of reference signal sounding occasions, a corresponding reference signal is transmitted using a corresponding precoding for each of one or more resources of the reference signal sounding occasion.

Aspect 7: The method of any one of Aspects 2 to 6, wherein: for each of the plurality of reference signal sounding occasions, multiple reference signals are transmitted over a plurality of frequency resources, the first one or more indications further comprise first one or more port numbers of one or more frequency resources of each of the first one or more reference signal sounding occasions, and the second one or more indications further comprise second one or more port numbers of one or more frequency resources of each of the second one or more reference signal sounding occasions.

Aspect 8: The method of any one of Aspects 1 to 7, wherein: for each of the plurality of reference signal sounding occasions, multiple reference signals are transmitted over a plurality of resources, each of the first one or more indications indicates a corresponding resource within one of the first one or more reference signal sounding occasions, and each of the second one or more indications indicates a corresponding resource within one of the second one or more reference signal sounding occasions.

Aspect 9: The method of any one of Aspects 1 to 8, further comprising receiving, from a second UE, fourth one or more indications of fourth one or more reference signal sounding occasions of the second UE associated with a third level of channel quality and fifth one or more indications of fifth one or more reference signal sounding occasions of the second UE associated with a fourth level of channel quality; and wherein the third indication is further based on the fourth one or more indications and the fifth one or more indications.

Aspect 10: A method for wireless communications by a user equipment (UE), the method comprising: receiving a plurality of reference signals in a plurality of reference signal sounding occasions; and transmitting, to a network entity, first one or more indications of first one or more reference signal sounding occasions associated with a first level of channel quality and second one or more indications of second one or more reference signal sounding occasions associated with a second level of channel quality.

Aspect 11: The method of Aspect 10, wherein the first one or more indications comprise first one or more indexes of the first one or more reference signal sounding occasions, and wherein the second one or more indications comprise second one or more indexes of the second one or more reference signal sounding occasions.

Aspect 12: The method of Aspect 11, further comprising receiving, from the network entity, a configuration of a number of first one or more indexes and a number of second one or more indexes to communicate to the network entity.

Aspect 13: The method of any one of Aspects 10 to 12, further comprising receiving, from the network entity, a configuration of a first threshold defining the first level of channel quality and a second threshold defining the second level of channel quality.

Aspect 14: The method of any one of Aspects 11 to 13, wherein: for each of the plurality of reference signal sounding occasions, multiple reference signals are received over a plurality of time resources, the first one or more indications further comprise third one or more indexes of one or more time resources of each of the first one or more reference signal sounding occasions, and the second one or more indications further comprise fourth one or more indexes of one or more time resources of each of the second one or more reference signal sounding occasions.

Aspect 15: The method of any one of Aspects 11 to 14, wherein: for each of the plurality of reference signal sounding occasions, multiple reference signals are received over a plurality of frequency resources, the first one or more indications further comprise first one or more port numbers of one or more frequency resources of each of the first one or more reference signal sounding occasions, and the second one or more indications further comprise second one or more port numbers of one or more frequency resources of each of the second one or more reference signal sounding occasions.

Aspect 16: The method of any one of Aspects 10 to 15, wherein: for each of the plurality of reference signal sounding occasions, multiple reference signals are received over a plurality of resources, each of the first one or more indications indicates a corresponding resource within one of the first one or more reference signal sounding occasions, and each of the second one or more indications indicates a corresponding resource within one of the second one or more reference signal sounding occasions.

Aspect 17: The method of any one of Aspects 10 to 16, further comprising: determining a first set of indications of a plurality of resources associated with the first level of channel quality; determining a second set of indications of a plurality of resources associated with the second level of channel quality; and determining the first one or more indications and the second one or more indications by alternating dropping indications from the first set of indications and the second set of indications until any remaining indications in the first set and the second set are below a threshold size.

Aspect 18: The method of any one of Aspects 10 to 17, further comprising: determining a first set of indications of a plurality of resources associated with the first level of channel quality; determining a second set of indications of a plurality of resources associated with the second level of channel quality; and determining the first one or more indications and the second one or more indications by first dropping up to a number of indications from the first set of indications and then dropping indications from the second set of indications until any remaining indications in the first set and the second set are below a threshold size.

Aspect 19: An apparatus, comprising: a memory; and one or more processors coupled to the memory, the one or more processors and the memory configured to perform a method in accordance with any one of Aspects 1-9.

Aspect 20: An apparatus, comprising means for performing a method in accordance with any one of Aspects 1-9.

Aspect 21: A non-transitory computer-readable medium comprising executable instructions that, when executed by one or more processors of an apparatus, cause the apparatus to perform a method in accordance with any one of Aspects 1-9.

Aspect 22: A computer program product embodied on a computer-readable storage medium comprising code for performing a method in accordance with any one of Aspects 1-9.

Aspect 23: An apparatus, comprising: a memory; and one or more processors coupled to the memory, the one or more processors and the memory configured to perform a method in accordance with any one of Aspects 10-18.

Aspect 24: An apparatus, comprising means for performing a method in accordance with any one of Aspects 10-18.

Aspect 25: A non-transitory computer-readable medium comprising executable instructions that, when executed by one or more processors of an apparatus, cause the apparatus to perform a method in accordance with any one of Aspects 10-18.

Aspect 26: A computer program product embodied on a computer-readable storage medium comprising code for performing a method in accordance with any one of Aspects 10-18.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 6 and/or FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A user equipment (UE) comprising:
a memory; and
a processor coupled with the memory, the memory and the processor configured to:
receive a plurality of reference signals in a plurality of reference signal sounding occasions; and
transmit, to a network entity, first one or more indications of first one or more reference signal sounding occasions associated with a first level of channel quality and second one or more indications of second one or more reference signal sounding occasions associated with a second level of channel quality.

2. The UE of claim 1, wherein the first one or more indications comprise first one or more indexes of the first one or more reference signal sounding occasions, and wherein the second one or more indications comprise second one or more indexes of the second one or more reference signal sounding occasions.

3. The UE of claim 2, wherein the memory and the processor are further configured to receive, from the network entity, a configuration of a number of first one or more indexes and a number of second one or more indexes to communicate to the network entity.

4. The UE of claim 2, wherein the memory and the processor are further configured to receive, from the network entity, a configuration of a first threshold defining the first level of channel quality and a second threshold defining the second level of channel quality.

5. The UE of claim 2, wherein:
for each of the plurality of reference signal sounding occasions, multiple reference signals are received over a plurality of time resources,
the first one or more indications further comprise third one or more indexes of one or more time resources of each of the first one or more reference signal sounding occasions, and
the second one or more indications further comprise fourth one or more indexes of one or more time resources of each of the second one or more reference signal sounding occasions.

6. The UE of claim 2, wherein:
for each of the plurality of reference signal sounding occasions, multiple reference signals are received over a plurality of frequency resources,
the first one or more indications further comprise first one or more port numbers of one or more frequency resources of each of the first one or more reference signal sounding occasions, and
the second one or more indications further comprise second one or more port numbers of one or more frequency resources of each of the second one or more reference signal sounding occasions.

7. The UE of claim 1, wherein:
for each of the plurality of reference signal sounding occasions, multiple reference signals are received over a plurality of resources,
each of the first one or more indications indicates a corresponding resource within one of the first one or more reference signal sounding occasions, and
each of the second one or more indications indicates a corresponding resource within one of the second one or more reference signal sounding occasions.

8. The UE of claim 1, wherein the memory and the processor are further configured to:
determine a first set of indications of a plurality of resources associated with the first level of channel quality;
determine a second set of indications of a plurality of resources associated with the second level of channel quality; and
determine the first one or more indications and the second one or more indications by alternating dropping indications from the first set of indications and the second set of indications until any remaining indications in the first set and the second set are below a threshold size.

9. The UE of claim 1, wherein the memory and the processor are further configured to:
determine a first set of indications of a plurality of resources associated with the first level of channel quality;
determine a second set of indications of a plurality of resources associated with the second level of channel quality; and
determine the first one or more indications and the second one or more indications by first dropping up to a number of indications from the first set of indications and then dropping indications from the second set of indications until any remaining indications in the first set and the second set are below a threshold size.

10. A network entity comprising:
a memory; and
a processor coupled with the memory, the memory and the processor configured to:
transmit a plurality of reference signals in a plurality of reference signal sounding occasions;
receive, from a user equipment (UE), first one or more indications of first one or more reference signal sounding occasions associated with a first level of channel quality and second one or more indications of second one or more reference signal sounding occasions associated with a second level of channel quality; and
transmit to a reconfigurable intelligent surface (RIS) controller a third indication of a beamforming configuration for use by the RIS controller, the third indication based on the first one or more indications and the second one or more indications.

11. The network entity of claim 10, wherein the first one or more indications comprise first one or more indexes of the first one or more reference signal sounding occasions, and wherein the second one or more indications comprise second one or more indexes of the second one or more reference signal sounding occasions.

12. The network entity of claim 11, wherein the memory and the processor are further configured to:
transmit, to the UE, a configuration of a number of first one or more indexes and a number of second one or more indexes to communicate to the network entity.

13. The network entity of claim 11, wherein the memory and the processor are further configured to:
transmit, to the UE, a configuration of a first threshold defining the first level of channel quality and a second threshold defining the second level of channel quality.

14. The network entity of claim 11, wherein:
for each of the plurality of reference signal sounding occasions, multiple reference signals are transmitted over a plurality of time resources;
the first one or more indications further comprise third one or more indexes of one or more time resources of each of the first one or more reference signal sounding occasions, and
the second one or more indications further comprise fourth one or more indexes of one or more time resources of each of the second one or more reference signal sounding occasions.

15. The network entity of claim 11, wherein for each of the plurality of reference signal sounding occasions, a corresponding reference signal is transmitted using a corresponding precoding for each of one or more resources of the reference signal sounding occasion.

16. The network entity of claim 11, wherein:
for each of the plurality of reference signal sounding occasions, multiple reference signals are transmitted over a plurality of frequency resources,
the first one or more indications further comprise first one or more port numbers of one or more frequency resources of each of the first one or more reference signal sounding occasions, and
the second one or more indications further comprise second one or more port numbers of one or more frequency resources of each of the second one or more reference signal sounding occasions.

17. The network entity of claim 10, wherein:
for each of the plurality of reference signal sounding occasions, multiple reference signals are transmitted over a plurality of resources,
each of the first one or more indications indicates a corresponding resource within one of the first one or more reference signal sounding occasions, and
each of the second one or more indications indicates a corresponding resource within one of the second one or more reference signal sounding occasions.

18. The network entity of claim 10, wherein the memory and the processor are further configured to:
receive, from a second UE, fourth one or more indications of fourth one or more reference signal sounding occasions of the second UE associated with a third level of channel quality and fifth one or more indications of fifth one or more reference signal sounding occasions of the second UE associated with a fourth level of channel quality; and
wherein the third indication is further based on the fourth one or more indications and the fifth one or more indications.

19. A method for wireless communications by a user equipment (UE), the method comprising:
receiving a plurality of reference signals in a plurality of reference signal sounding occasions; and
transmitting, to a network entity, first one or more indications of first one or more reference signal sounding occasions associated with a first level of channel quality and second one or more indications of second one or more reference signal sounding occasions associated with a second level of channel quality.

20. The method of claim 19, wherein the first one or more indications comprise first one or more indexes of the first one or more reference signal sounding occasions, and wherein the second one or more indications comprise second one or more indexes of the second one or more reference signal sounding occasions.

21. The method of claim 20, further comprising receiving, from the network entity, a configuration of a number of first one or more indexes and a number of second one or more indexes to communicate to the network entity.

22. The method of claim 20, further comprising receiving, from the network entity, a configuration of a first threshold defining the first level of channel quality and a second threshold defining the second level of channel quality.

23. The method of claim 20, wherein:
for each of the plurality of reference signal sounding occasions, multiple reference signals are received over a plurality of time resources,
the first one or more indications further comprise third one or more indexes of one or more time resources of each of the first one or more reference signal sounding occasions, and
the second one or more indications further comprise fourth one or more indexes of one or more time resources of each of the second one or more reference signal sounding occasions.

24. The method of claim 20, wherein:
for each of the plurality of reference signal sounding occasions, multiple reference signals are received over a plurality of frequency resources,
the first one or more indications further comprise first one or more port numbers of one or more frequency resources of each of the first one or more reference signal sounding occasions, and
the second one or more indications further comprise second one or more port numbers of one or more frequency resources of each of the second one or more reference signal sounding occasions.

25. A method for wireless communications by a network entity, the method comprising:
transmitting a plurality of reference signals in a plurality of reference signal sounding occasions;
receiving, from a user equipment (UE), first one or more indications of first one or more reference signal sounding occasions associated with a first level of channel quality and second one or more indications of second one or more reference signal sounding occasions associated with a second level of channel quality; and
transmitting to a reconfigurable intelligent surface (RIS) controller a third indication of a beamforming configuration for use by the RIS controller, the third indication based on the first one or more indications and the second one or more indications.

26. The method of claim 25, wherein the first one or more indications comprise first one or more indexes of the first one or more reference signal sounding occasions, and wherein the second one or more indications comprise second one or more indexes of the second one or more reference signal sounding occasions.

27. The method of claim 26, further comprising transmitting, to the UE, a configuration of a number of first one or more indexes and a number of second one or more indexes to communicate to the network entity.

28. The method of claim 26, further comprising transmitting, to the UE, a configuration of a first threshold defining the first level of channel quality and a second threshold defining the second level of channel quality.

29. The method of claim 26, wherein:
for each of the plurality of reference signal sounding occasions, multiple reference signals are transmitted over a plurality of time resources;
the first one or more indications further comprise third one or more indexes of one or more time resources of each of the first one or more reference signal sounding occasions, and
the second one or more indications further comprise fourth one or more indexes of one or more time resources of each of the second one or more reference signal sounding occasions.

30. The method of claim 26, wherein for each of the plurality of reference signal sounding occasions, a corresponding reference signal is transmitted using a corresponding precoding for each of one or more resources of the reference signal sounding occasion.
